(19) United States
(12) Patent Application Publication
(10) Pub. No.: US 2001/0037286 A1
(43) Pub. Date: Nov. 1, 2001

(54) Vehicle wheel trading method

(76) Inventors: Yasuto Tohi, Saitama (JP); Kazuhiro Akitomo, Tokyo (JP)

Correspondence Address: SUGHRUE, MION, ZINN,, MACPEAK & SEAS, 2100 Pennsylvania Avenue, N.W., Washington, DC, 20037, US

(21) Appl. No.: 09/836,320

(22) Filed: Apr. 18, 2001

(30) Foreign Application Priority Data
Apr. 19, 2000 (JP) 2000-117446
Jun. 5, 2000 (JP) 2000-167146

(51) Int. Cl. G06F 17/60

(52) U.S. Cl. 705/37

(57) ABSTRACT

A vehicle wheel trading method is provided in which a customer can obtain a wheel emphasizing a personal taste, being different from the others, and having a highly original piece of design by reflecting an individual request on a wheel maker. A system, in which a wheel maker becomes a main constituent to trade vehicle wheels between the wheel maker and a customer by using a communication network such as Internet to which a terminal device of the wheel maker and a terminal device of the customer are connected, makes it possible that the wheel maker advertises a wheel basic specification to the customer (indication of acceptance of a partially special specification), receives a request for a partially special specification from the customer, then shows the customer a completed wheel specification incorporating the partially special specification in the wheel basic specification, obtains an order from the customer, and then manufactures a specification-completed wheel and delivers the specification-completed wheel manufactured, to the customer.

### BACKGROUND OF THE INVENTION

The present invention relates to a trading art of a vehicle wheel for an automobile or the like, and particularly to an art of being effectively applied to a vehicle wheel trading method preferable as a trading configuration of a wheel having a highly original piece of design for private use.

Recently, improvement of fuel consumption of an automobile has been greatly watched in close-up because of environmental problems and, thereby, decrease in weight of an automobile has been studied. Particularly, because a request for decrease in weight of parts has been severe, many cases have been seen in which iron parts have been changed to light-alloy parts made of an aluminum alloy or magnesium alloy. As one of these cases, change of a vehicle wheel made of iron to a vehicle wheel made of a light alloy has been progressed for weight decrease and fashionable property. At present, the percentage of automobiles on which install aluminum wheels made of an aluminum alloy in a line is considerably increased about 40 to 45%. Moreover, aluminum wheels having various pieces of design are used for automobiles because of fashionable property.

These aluminum wheels with various pieces of design are shown, for example, by an example in FIG. 15. In the example, a wheel maker receives designation of a general specification of a wheel from a wheel supplier or car maker (\mathring{1}), and manufactures a completed wheel based on the general specification (\mathring{2}), and, thereafter, delivers the completed wheel to the wheel supplier or car maker (\mathring{3}). Then, the completed wheel can be obtained by the fact that between the wheel supplier or car maker and a customer (individual etc.), the customer gives an order for the completed wheel to the wheel supplier (\mathring{4}), and purchases the completed wheels from the wheel supplier (\mathring{5}), or a car which installs the completed wheel, from the car maker (\mathring{6}).

### SUMMARY OF THE INVENTION

In the case of the above wheel trading configuration, however, a customer can obtain only a wheel having any kinds of design designated by a wheel supplier or car maker because a wheel maker manufactures a wheel in accordance with the general specification designated by the wheel supplier or car maker. Thus, as design of a wheel loses personality, the customer does not meet his or her request for installing a wheel emphasizing an individual taste, being different from the others, and having his or her original piece of design, at his or her car.

An object of the present invention is to provide a vehicle wheel trading method in which a customer can obtain such a wheel emphasizing a his or her taste, being different from the others, and having his original piece of design, that his request is individually reflected on manufacturing of the wheel by a wheel maker.

To achieve the above object, the present invention uses a vehicle wheel trading method for realizing a trading configuration of a completed wheel incorporating a partially special specification requested from a customer (such as an individual, group, company, or wheel supplier) in a wheel basic specification of a wheel-basic-specification-designating company (such as a wheel maker or wheel supplier).

That is, a vehicle wheel trading method of the present invention comprises a step of communicating a wheel basic specification of a wheel-basic-specification-designating company to a customer; a step of communicating a request for a partially special specification of the customer as corresponding to the wheel basic specification, to a wheel maker; a step of manufacturing a specification-completed wheel incorporating the partially special specification in the wheel basic specification by a manufacturing means which the wheel maker uses; and a step of delivering the specification-completed wheel manufactured by the wheel maker to the customer. A step of communicating a wheel basic specification and a request for a partially special specification of the customer is generally executed by a transmission means. However, the step of the communicating may use a directly handing means and any means of being communicated to the other party. The step of delivering a completed wheel is generally delivered by a transport means. However, as long as delivering to the customer, the step of the delivering may use one of other various means including a means for delivering the specification-completed wheel manufactured when the customer directly comes to receive the wheel and a means for delivering the specification-completed wheel manufactured when the customer comes to receive the completed wheel kept in a predetermined place.

In the case of a first trading configuration of the above-mentioned vehicle wheel trading method, a wheel-basic-specification-designating company is a wheel maker and the wheel maker becomes a main constituent to perform the transaction between the wheel maker and a customer. Thereby, as a completed wheel trading configuration, it is possible to provide a specification-completed wheel incorporating a partially special specification requested by the customer in the wheel basic specification, from the wheel maker to the customer.

In the case of a second trading configuration of the above-mentioned vehicle wheel trading method, a wheel-basic-specification-designating company is a wheel maker, a wheel broker is present between the wheel maker and a customer, and the wheel maker becomes a main constituent to perform transaction between the wheel maker and the customer via the wheel broker. Thereby, as a completed wheel trading configuration, it is possible to provide a specification-completed wheel incorporating a partially special specification requested by a customer in a wheel basic specification from the wheel maker to the customer through the wheel broker.

In the case of a third trading configuration of the above-mentioned vehicle wheel trading method, a wheel-basic-specification-designating company is a wheel supplier, the wheel supplier is present between the wheel maker and a customer, the wheel supplier becomes a main constituent to perform transactions between the wheel maker and the customer via the wheel supplier, and the wheel supplier communicates designation of a wheel basic specification to the wheel maker. Thereby, as a completed wheel trading configuration, it is possible to provide a specification-completed wheel incorporating a partially specific specification requested by the customer in a wheel basic specification, from the wheel maker to the customer through a wheel supplier.

In the case of a fourth trading configuration of the above-mentioned vehicle wheel trading method, similarly to the case of the third trading configuration, the transaction is performed between a wheel maker and a customer via a wheel supplier present between the wheel maker and the customer. However, the fourth trading configuration is different from the third trading configuration in that a wheel-basic-specification-designating company is a wheel maker and the wheel maker becomes a main constituent. Thereby, as a completed wheel trading configuration, it is possible to provide a specification-completed wheel incorporating a partially special specification requested by a customer in a wheel basic specification from the wheel maker to the customer through the wheel supplier.

Moreover, in the above vehicle wheel trading method, it is possible to widely incorporate various specifications that an individual want to capture such as specifications provided with a name such as an individual name or company name, character, mark, family crest, pattern, picture, partially individual coating, sensor, or LED as the partially special specification.

Moreover, in the case of the above vehicle wheel trading method, it is possible to perform the transaction between the wheel maker and the customer, between the wheel maker, the wheel broker, and the customer, or between the wheel maker, the wheel supplier, and the customer by using a communication network serving as a transmission means, through terminals of the wheel maker, customer, wheel broker, and wheel supplier connected to the communication network. However, the transaction is not restricted to the above mentioned.

Therefore, according a vehicle wheel trading method of the present invention, it is possible to realize a new trading configuration for trading a wheel having highly original design, by using an individual-sold configuration instead of a conventional OEM-sold configuration which a wheel supplier has as a vehicle wheel trading configuration. Moreover, it is possible to provide a personal who has chiefly individuality among young or rich middle-aged people, an individual having an adherence, or a person adhering to the appearance of his or her own car with a personal wheel or originally designed wheel for individual use, or, above all, a single wheel of his or her own or a single wheel in the world. That is, it is possible to provide the customer with a wheel emphasizing a personal taste such as a name, a piece of design, and/or the like and having a highly original piece of design other than other pieces of design.

### BRIEF DESCRIPTION OF THE DRAWINGS

FIG. 1 is a conceptual illustration showing a vehicle wheel trading method of a first embodiment of the present invention.

FIG. 2 is a schematic block diagram showing a system for executing the vehicle wheel trading method of the first embodiment of the present invention.

FIG. 3 is a flowchart showing the vehicle wheel trading method of the first embodiment of the present invention.

FIG. 4 is a perspective view showing an aluminum wheel according to a wheel basic specification in the first embodiment of the present invention.

FIG. 5A is a plane view showing the aluminum wheel in FIG. 4.

FIG. 5B is a sectional view taken along line B-B′ in FIG. 5A in the first embodiment of the present invention.

FIG. 6A is a plane view showing a name-provided aluminum wheel according to a completed wheel specification.

FIG. 6B is a sectional view taken along line B-B′in FIG. 6A in the first embodiment of the present invention.

FIG. 7 is a conceptual illustration showing a vehicle wheel trading method of a second embodiment of the present invention.

FIG. 8 is a schematic block diagram showing a system for executing the vehicle wheel trading method of the second embodiment of the present invention.

FIG. 9 is a flowchart showing the vehicle wheel trading method of the second embodiment of the present invention.

FIG. 10 is a conceptual illustration showing a vehicle wheel trading method of a third embodiment of the present invention.

FIG. 11 is a schematic block diagram showing a system for executing the vehicle wheel trading method of the third embodiment of the present invention.

FIG. 12 is a flowchart showing the vehicle wheel trading method of the third embodiment of the present invention.

FIG. 13 is a conceptual illustration showing a vehicle wheel trading method of a forth embodiment of the present invention.

FIG. 14 is a flowchart showing a vehicle wheel trading method by a system for executing a vehicle wheel trading method of the forth embodiment of the present invention.

FIG. 15 is a conceptual illustration showing a conventional vehicle wheel trading method.

### DESCRIPTION OF THE PREFERRED EMBODIMENTS

Embodiments of the present invention will be described below by referring to the accompanying drawings. In all drawings for explaining the embodiments, the same members are provided with the same symbol and repetitive descriptions of the same members will be omitted.

(First Embodiment)

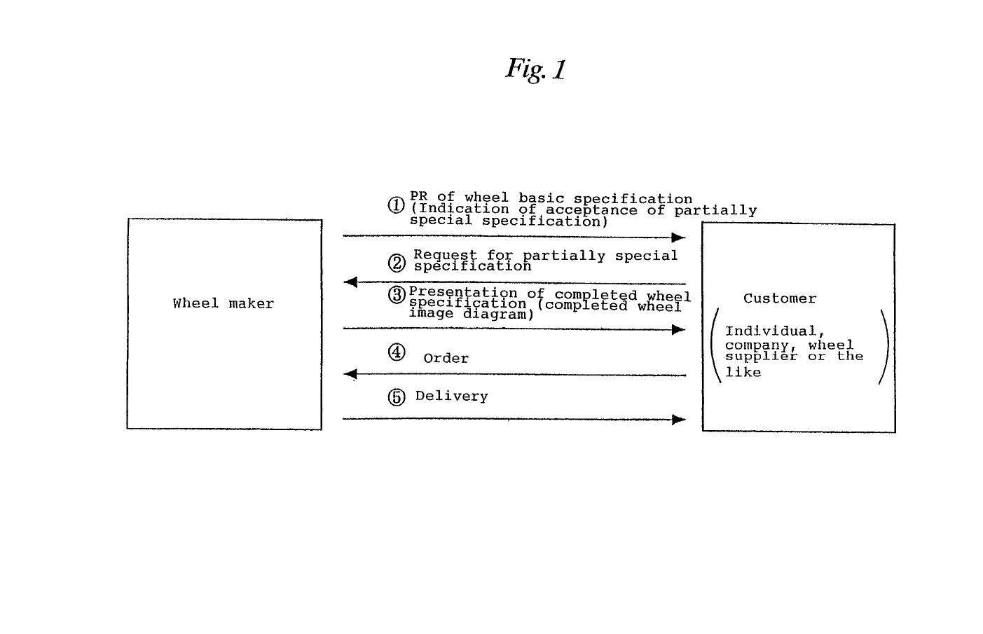

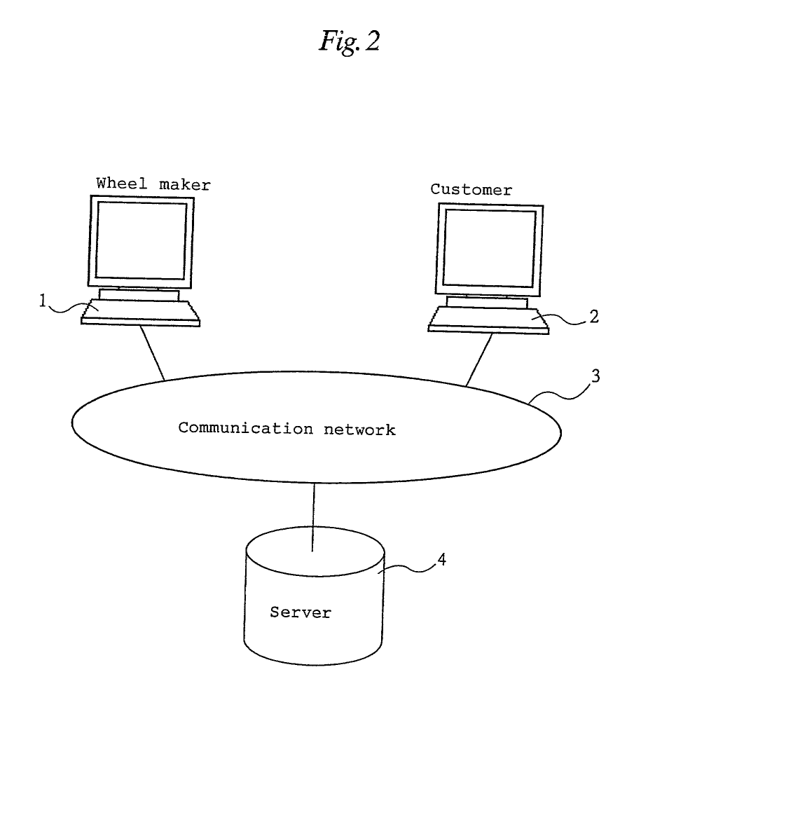

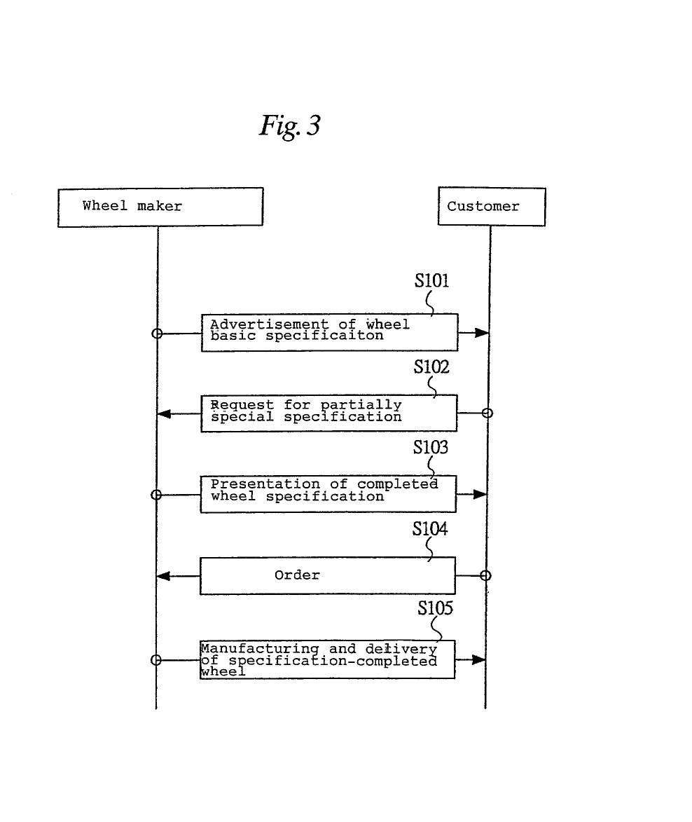

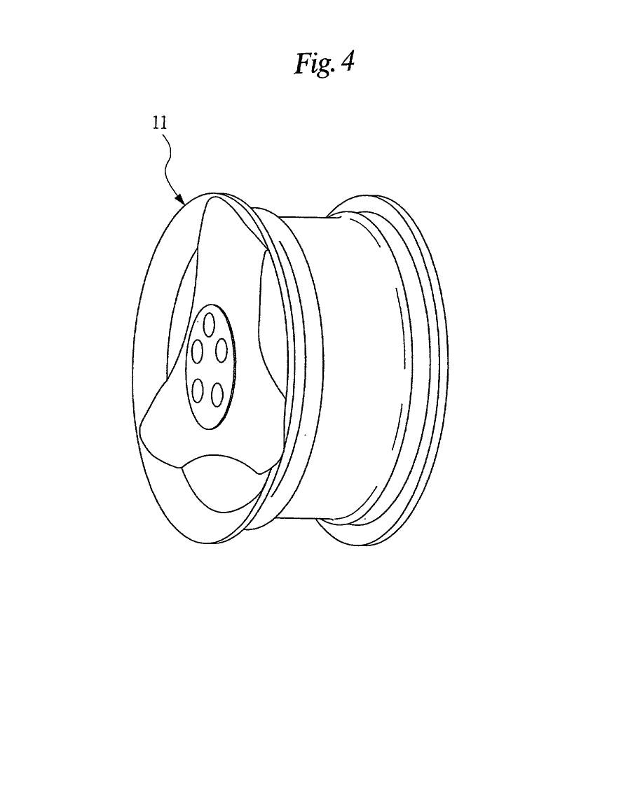

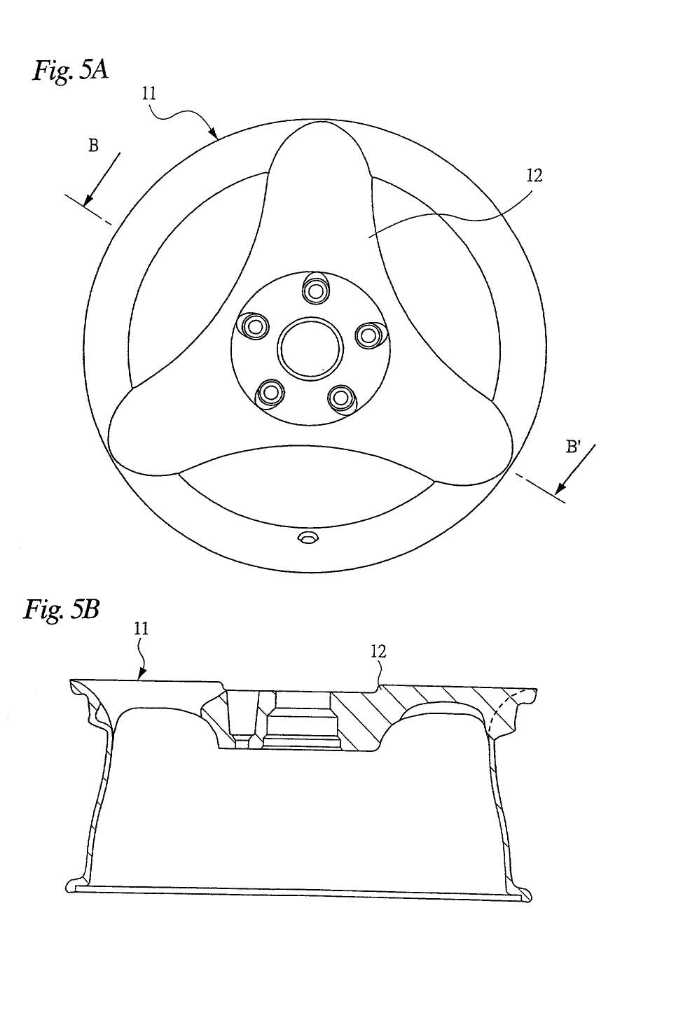

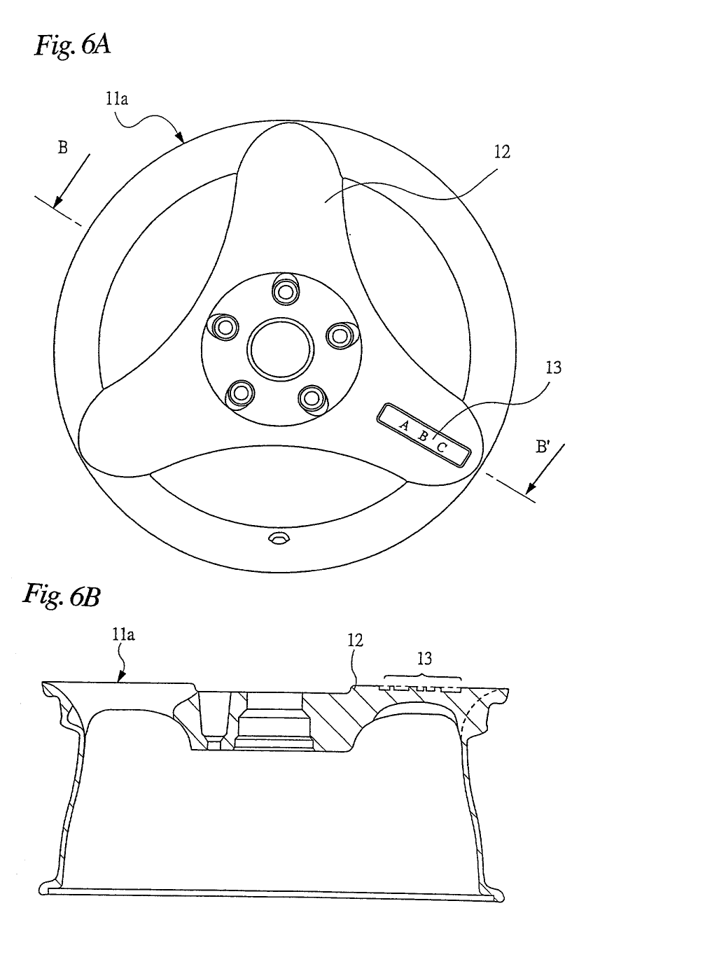

FIG. 1 is a conceptual illustration showing a vehicle wheel trading method of a first embodiment of the present invention. FIG. 2 is a schematic block diagram showing a system for executing the vehicle wheel trading method of the embodiment in FIG. 1. FIG. 3 is a flowchart showing a vehicle wheel trading method. FIG. 4 is a perspective view showing an aluminum wheel according to a wheel basic specification. FIG. 5A is a plane view showing the aluminum wheel in FIG. 4. FIG. 5B is a sectional view taken along line B-B′in FIG. 5A. FIG. 6A is a plane view showing an aluminum wheel provided with a name according to a completed wheel specification. FIG. 6B is a sectional view taken along line B-B′in FIG. 6A.

First, a conceptual example of the vehicle wheel trading method of this embodiment is described below by referring to FIG. 1. This embodiment shows a trading configuration in which a wheel-basic-specification-designating company is a wheel maker, the wheel maker becomes a main constituent to trade vehicle wheels between the wheel maker and a customer (including individual, group, company, and wheel supplier). The wheel maker advertises a wheel basic specification to customers (indicating acceptance of a partially special specification) (\mathring{1}), accepts a request for the partially special specification from the customer (\mathring{2}), then shows the customer a completed wheel specification such as a completed wheel image diagram in which the partially special specification is incorporated in the wheel basic specification (\mathring{3}), obtains an order from the customer (\mathring{4}), and then manufactures a specification-completed wheels according to the completed wheel specification and delivers the specification-completed wheel manufactured, to the customer (\mathring{5}). Symbols \mathring{1} to \mathring{5} in FIG. 1 correspond to described hereinafter steps S101 to S105 in FIG. 3, respectively.

Then, an example of a system for executing the vehicle wheel trading method of this embodiment according to the concept in FIG. 1 is described below by referring to FIG. 2. This embodiment uses, for example, a system for trading a vehicle wheel between a wheel maker and a customer by using a communication network. The system is constituted of a terminal device 1 of the wheel maker, a terminal device 2 of the customer, a communication network to which the terminal device 1 of the wheel maker and the terminal device 2 of the customer are connected, and the like. In the system, information can be bidirectionally transceived between the terminal device 1 of the wheel maker and the terminal device 2 of the customer through the communication network 3.

The terminal device 1 of the wheel maker is constituted of, for example, a personal computer as an example. The personal computer is not illustrated at detail in which a central processing unit for controlling the whole of the terminal device 1, a memory unit for storing control programs and various types of data, input units such as a keyboard and a mouse, a display unit such as a CRT or liquid-crystal monitor, an output unit such as a printer, and the like are provided. The memory unit of the terminal device 1 stores a piece of communication software for accessing the communication network 3, a piece of retrieving software for retrieving the information on the communication network 3, and the like. By the personal computer, it is possible to retrieve the information on the communication network 3 by accessing the communication network 3 from the input unit and to display the retrieved information on the display unit, or output the retrieved information from the output unit. Moreover, it is possible to store various pieces of information about vehicle wheels in a database 4 of a server constructed on the communication network 3 from the input unit of the terminal device 1.

As an example, the terminal device 2 of the customer is, for example, constituted of a personal computer provided with a central processing unit, a memory unit, an input unit, a display unit, an output unit, and the like similarly to the case of the terminal device 1 of the wheel maker. By the personal computer, it is possible to retrieve the information on the communication network 3 by accessing the communication network 3 from the input unit and to display the retrieved information on the display unit, or output the retrieved information from the output unit. Moreover, it is possible to store various pieces of information about vehicle wheels in a database 4 of a server constructed on the communication network 3 from the input unit.

The communication network 3 is constituted of, for example, Internet as an example, and the database 4 of the wheel maker is constructed in a server on this Internet. The database 4 of the server stores various pieces of information about vehicle wheels including a wheel basic specification being input from the input unit of the terminal device 1 of the wheel maker, a partially special specification being input from the input unit of the terminal device 2 of the customer, and the like. The communication network 3 is not restricted to Internet but it can be applied to other network such as PC-VAN.

As a function of this embodiment, an example of a vehicle wheel trading method to be executed between a wheel maker and a customer is described below in accordance with FIG. 3 by referring to FIGS. 4 to 6.

(1) A wheel maker previously accesses the communication network 3 from the input unit of the terminal 1, retrieves the database 4 of the wheel maker constructed on the communication network 3 to display the database 4 on the browser of the display unit, inputs various pieces of information (including information capable of capturing a partially special specification of a customer) about vehicle wheels including a wheel basic specification and the like on the browser, and stores the various pieces of information in the database 4. Thereby, the wheel basic specification of the wheel maker is kept open to the public on the communication network 3.

(2) First, the customer accesses the communication network 3 from the input unit of the terminal 2, retrieves the database 4 of the wheel maker constructed in the server on the communication network 3, and displays various pieces of information about vehicle wheels including the wheel basic specification and the like stored in the database 4 on the browser of the display unit. Thereby, it is possible to advertise the wheel basic specification of the wheel maker to the customer (step S101).

The vehicle wheels according to the wheel basic specification include, for example, the aluminum-alloy aluminum wheel 11 made of an aluminum alloy. The aluminum-ally aluminum wheel 11 is a spoke-type light-alloy wheel as shown in FIGS. 4 and 5A and 5B. The aluminum wheel 11 is provided with a disk design portion 12 which is a portion showing a basic design of the whole wheel such as a display window or a spoke position. This embodiment can be applied not only to the spoke-type aluminum wheel 11 but also to light-alloy wheels such as a dish-type aluminum wheel and a magnesium wheel made of a magnesium alloy and moreover to all vehicle wheels including an iron wheel and the like. Particularly, the demand for a light-alloy wheel has increased because the wheel has lightweight and fashionable property.

(3) Moreover, the customer inputs various pieces of information about vehicle wheels including a partially special specification and the like according to the wheel basic specification from the input unit of the terminal 2 while various pieces of information about vehicle wheels including the wheel basic specification and the like are displayed on the browser of the display unit. Thereby, the partially special specification requested by the customer is stored in the database 4 of the wheel maker.

(4) Then, the wheel maker similarly accesses the communication network 3 from the input unit of the terminal 1, retrieves the database 4 of the wheel maker constructed in the server on the communication network 3, and displays various pieces of information about vehicle wheels including the wheel basic specification and the partially special specification in accordance with the wheel basic specification stored in the database 4 on the browser. Thereby, the wheel maker can receive a request for the partially special specification from the customer (step S102).

The partially specific specification includes, for example, names such as a personal name and a company name. This embodiment can be widely applied to such various specifications that a customer such as an individual wants to capture not only a name but also character, mark, family crest, pattern, picture, partially individual coating, sensor such as a pneumatic sensor, LED (light emitting diode), and the like.

(5) Furthermore, the wheel maker makes and inputs various pieces of information about vehicle wheels including a completed wheel specification such as a completed wheel image diagram obtained by incorporating a partially special specification in the wheel basic specification from the input unit of the terminal 1 while displaying various pieces of information about vehicle wheels including the wheel basic specification and a partially special specification in accordance with the wheel basic specification on the browser of the display unit. Thereby, a completed wheel specification is stored in the database 4 of the wheel maker.

(6) Then, the customer similarly accesses the communication network 3, retrieves the database 4 of the wheel maker constructed in the server on the communication network 3, and displays various pieces of information about vehicle wheels including a completed wheel specification obtained by incorporating a partially special specification in the basic wheel specification stored in the database 4 on the browser of the display unit. Thereby, it is possible to present the completed wheel specification from the wheel maker to the customer (step S103).

(7) Moreover, the customer inputs various pieces of information necessary for the order of a vehicle wheel based on the completed wheel specification from the input unit of the terminal 2 while displaying various pieces of information about vehicle wheels including the completed wheel specification on the browser of the display unit. Thereby, the order information of the customer is stored in the database 4 of the wheel maker.

(8) Then, the wheel maker similarly accesses the communication network 3 from the input unit of the terminal 1, retrieves the database 4 of the wheel maker constructed in the server on the communication network 3, and displays various pieces of information necessary for the order of a vehicle wheel based on the completed wheel specification stored in the database 4 on the browser of the display unit. Thereby, the wheel maker can receive the order of a vehicle wheel based on the completed wheel specification from the customer (step S104).

(9) Then, the wheel maker manufactures a specification-completed wheel according to the completed wheel specification incorporating a partially special specification in the wheel basic specification, by using a wheel manufacturing system serving as wheel manufacturing means and delivers the specification-completed wheel manufactured, to the customer by a transport means. Moreover, it is possible to use any other method such as a method of delivering the specification-completed wheel manufactured, to the customer who directly comes to receive the specification-completed wheel manufactured or a method of delivering the specification-completed wheel manufactured, to the customer who comes to a predetermined place at which the specification-completed wheel manufactured is kept. Thereby, in the transaction of vehicle wheels between the wheel maker and the customer, it is possible to deliver the specification-completed wheel manufactured, from the wheel maker to the customer (step S105).

For example, as shown in FIGS. 6A and 6B, in comparison with the spoke-type aluminum wheel 11 based on the wheel basic specification shown FIGS. 4 and 5A and 5B, the specification-completed wheel based on the complete wheel specification becomes a specification-completed wheel manufactured in which an intrinsic design portion 13 serving as a portion having highly original design is incorporated in the spoke portion of the disk design portion 12, by using a name such as the above-mentioned personal name or company name as a partially special specification. The name-provided aluminum wheel 11a is an example in which the name of characters “ABC” is drawn on the intrinsic design portion 13 of the disk design portion 12, the intrinsic design portion 13 is recessed from the surface of the disk design portion 12, and a position of the name of “ABC” is protruded, and the name is flush with the surface of the disk design portion 12. However, the intrinsic design portion 13 may be also protruded from the surface of the disk design portion 12. Moreover, the portion 13 may be protruded from the surface of the disk design portion 12 and the name of “ABC” may be recessed. Though only characters of “ABC” are shown in the case of this embodiment, it is needless to say that the characters are changed correspondingly to a name and, moreover, can be widely applied to the above-mentioned various partially special specifications. Moreover, to make the name portion remarkable by coloring the name portion different from other portions, the name surface may be diamond-cut to produce the metallic luster of a wheel material, form the name surface into a brilliant surface by transparently clear coating, and apply powder primer coating and clear coating to the casting surface of other portion. Moreover, color coating can be selected according to necessity.

Moreover, a process for manufacturing the name-provided aluminum wheel 11a can use any one of low-pressure casting process, gravity casting process, high-pressure casting process, forging process, and forging cast process. For example, when a small number of name-provided aluminum wheels 11a for individuals is manufactured by the low-pressure casting process, it is possible to manufacture a name-provided aluminum wheel 11a including a partially special specification requested by the customer by forming a nesting portion on a mold face corresponding to the disk design portion 12 of the aluminum wheel 11a, by inserting a nest for forming the intrinsic design portion 13 of a name requested by a customer, into the nesting portion, and by casting the aluminum wheel 11a, that is, by replacing the nest only at the portion of the mold without changing the mold. Though the above-mentioned process is described by using an integrally cast (one-piece) aluminum wheel, the process can be also applied to two-piece or three-piece wheel.

Therefore, according to this embodiment, a wheel maker becomes a main constituent by using the communication network 3 such as Internet, advertises a wheel basic specification to a customer, receives a customer's request for a partially special specification such as a name, then presents a completed wheel specification incorporating the name in the aluminum wheel 11, to the customer. And, after receiving an order from the customer, the wheel maker can manufacture the name-provided aluminum wheel 11a based on a specification-completed wheel, and deliver it to the customer. Therefore, it is possible to provide a personal or originally designed wheel as a trading configuration of a completed wheel such as the name-provided wheel 11a or the like, from the wheel maker to the customer. The personal or originally designed wheel incorporates a partially special specification, such as a name, design or the like, being requested by the customer in a wheel basic specification and emphasizing a personal taste, and is different from the others, and has highly original design relative to an object of the customer such as an individual or the like.

(Second Embodiment)

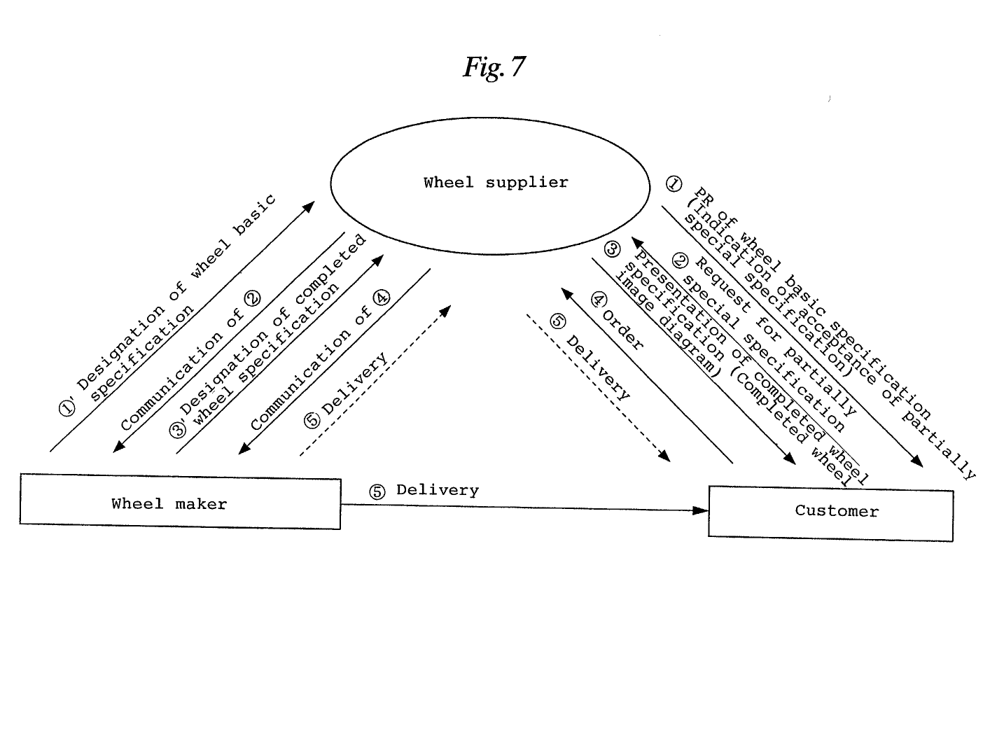

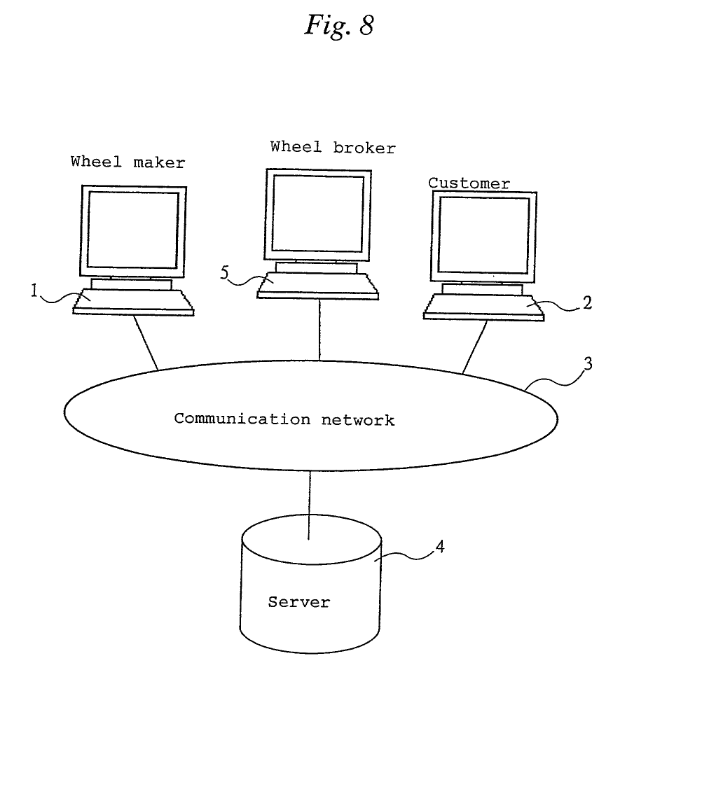

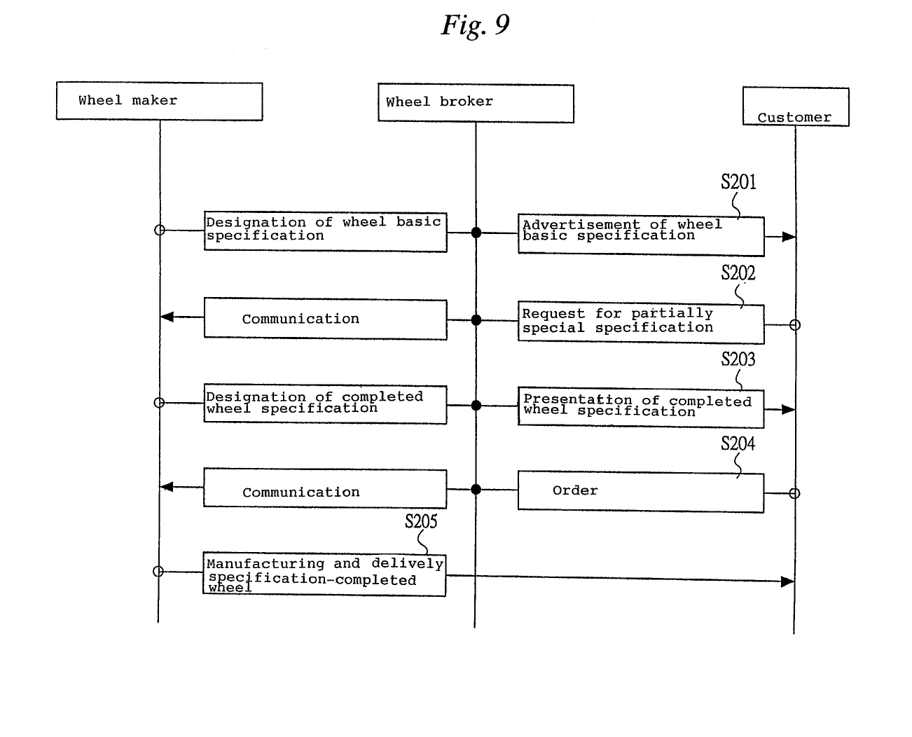

FIG. 7 is a conceptual illustration showing a vehicle wheel trading method of a second embodiment of the present invention. FIG. 8 is a schematic block diagram showing a system for executing the vehicle wheel trading method of this embodiment. FIG. 9 is a flow chart showing a vehicle wheel trading method.

In the case of the vehicle wheel trading method of this embodiment, a wheel-basic-specification-designating company is similarly a wheel maker. However, the second embodiment is different from the first embodiment in that a wheel maker becomes a main constituent and vehicle wheels are traded between the customer and the wheel maker through a wheel broker. That is, in the case of this embodiment, as shown by an example in FIG. 7, every transaction is performed via a wheel broker. The wheel broker receives designation of a wheel basic specification from a wheel maker and advertises the wheel basic specification to a customer (\mathring{1}, \mathring{1}′), receives a request for a partially special specification of a customer and then communicates the request to the wheel maker (\mathring{2}), receives designation of a completed wheel image diagram incorporating the partially special specification in a wheel basic specification, from the wheel maker, and thereafter presents the completed wheel specification to the customer (\mathring{3}, \mathring{3}′), receives an order from the customer (\mathring{4}), and then manufactures a specification-completed wheel according to the completed wheel specification and delivers the specification-completed wheel manufactured, to the customer (or through the wheel broker)( \mathring{5}). Symbols \mathring{1} to \mathring{5} in FIG. 7 correspond to described hereinafter steps S201 to S205 in FIG. 9, respectively.

The system for executing the vehicle wheel trading method of this embodiment according to the concept in FIG. 7 uses a system for trading vehicle wheels between a wheel maker and a customer through a wheel broker. Such system is constituted by connecting not only the terminal device 1 of the wheel maker and the terminal device 2 of the customer but also the terminal device 5 of the wheel broker, to the communication network 3 as shown by an example in FIG. 8.

Therefore, as shown by an example in FIG. 9, the vehicle wheel trading method of this embodiment makes it possible that a wheel broker receives designation of a wheel basic specification from a wheel maker and advertises the wheel basic specification to a customer (step S201), receives a request for a partially special specification of the customer and communicates the request to the wheel maker (step S202), receives designation of an aluminum completed wheel specification from the wheel maker and presents the designation to the customer (step S203), obtains an order from the customer and then communicates the order to the wheel maker (step S204), and directly delivers a name-provided aluminum wheel which the wheel maker manufactures by a wheel manufacturing means, from the wheel maker to the customer through a transport means, or such a method that the customer directly comes to receive the name-provided aluminum wheel, or the like (step S205)(or it is also possible to deliver the wheel from the wheel maker through a wheel broker).

Therefore, according to this embodiment, a customer corresponds to a wheel broker. However, the wheel maker becomes a main constituent. And, it is possible to provide a personal or original design wheel as a trading configuration of a completed wheel from the wheel maker to the customer through the wheel broker, similarly to the above-mentioned first embodiment. The personal or original design wheel incorporates a partially special specification such as a name, design or the like, being requested by the customer in a wheel basic specification and emphasizing a personal taste, and is different from the others, and has highly original design relative to an object of the customer such as an individual or the like.

(Third Embodiment)

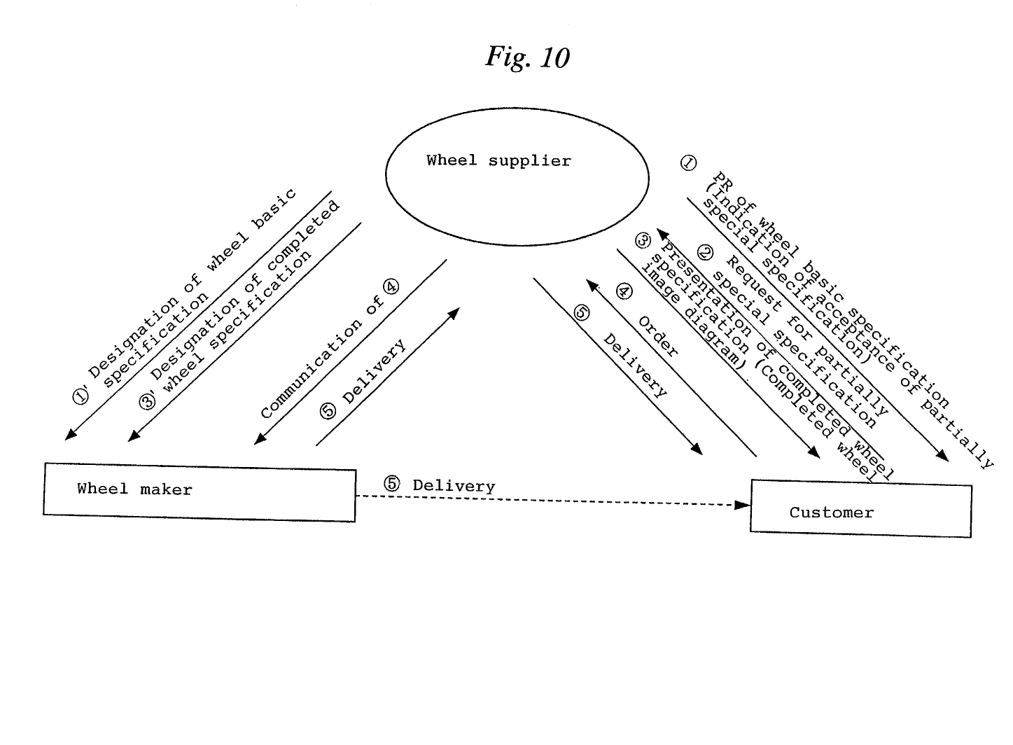

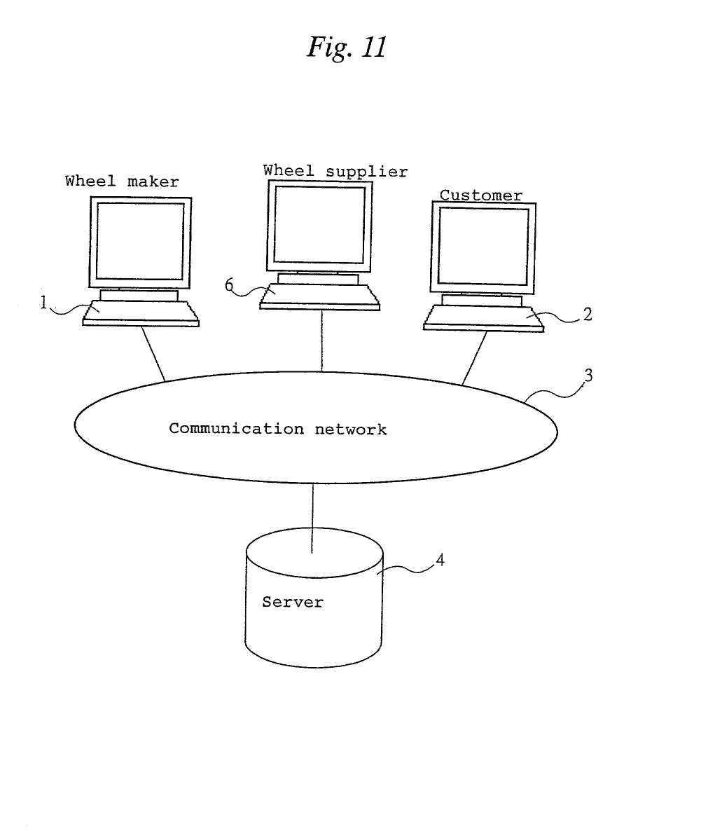

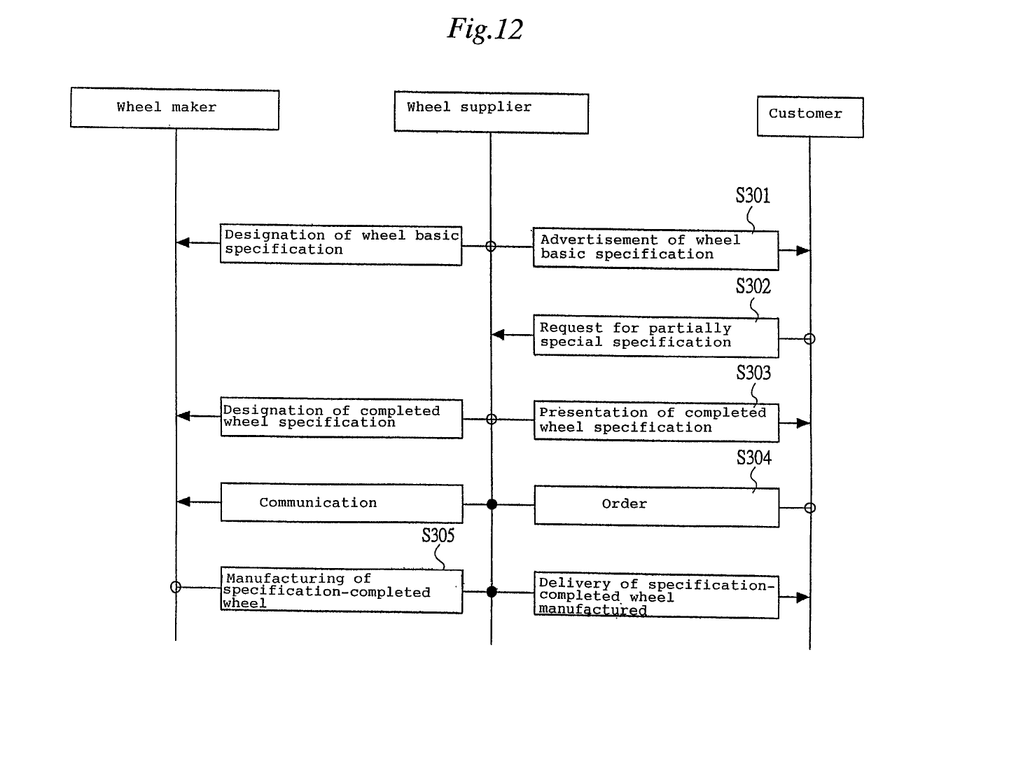

FIG. 10 is a conceptual illustration showing a vehicle wheel trading method of a third embodiment of the present invention. FIG. 11 is a schematic block diagram showing a system for executing the vehicle wheel trading method of this embodiment. FIG. 12 is a flowchart showing a vehicle wheel trading method.

The vehicle wheel trading method of this embodiment is different from the vehicle wheel trading methods of the embodiments 1 and 2 in that a wheel-basic-specification-designating company is a wheel supplier, and the wheel supplier becomes a main constituent and designates a wheel basic specification to a wheel maker and vehicle wheels are traded between a customer and the wheel supplier. That is, in the case of this embodiment, as shown by an example in FIG. 10, every transaction is performed via a wheel supplier. The wheel supplier designates a wheel basic specification to a wheel maker and advertises the wheel basic specification to a customer (\mathring{1}, \mathring{1}′), receives a request for a partially special specification from the customer (\mathring{2}), designates a completed wheel specification to the wheel maker and simultaneously shows the customer a completed wheel specification such as a completed wheel image diagram incorporating the partially special specification in the wheel basic specification (\mathring{3}, \mathring{3}′), obtains an order from the customer (\mathring{4}), and thereafter delivers a specification-completed wheel to the customer (or the wheel maker directly delivers the specification-completed wheel to the customer). Symbols \mathring{1} to \mathring{5} in FIG. 10 correspond to described hereinafter steps S301 to S305 in FIG. 12, respectively.

A system for executing the vehicle wheel trading method of this embodiment according to the concept shown in FIG. 10 is, for example, shown as an example in FIG. 11. In the system, vehicle wheels are traded between a wheel maker and a customer through a wheel supplier. The system is constituted by connecting not only the terminal device 1 of the wheel maker and the terminal device 2 of the customer but also the terminal device 6 of the wheel supplier, to the communication network 3.

Accordingly, as shown by an example in FIG. 12, the vehicle wheel trading method of this embodiment makes it possible that a wheel supplier designates a wheel basic specification to a wheel maker and advertises the wheel basic specification to a customer (step S301), receives a request for a partially special specification from the customer (step S302), designates a completed wheel specification to the wheel maker and simultaneously shows the customer a completed wheel specification such as a completed wheel image diagram or the like of an aluminum wheel (step S303), obtains an order from the customer (step S304), communicates the order to the wheel maker, receives a name-provided aluminum wheel which the customer manufactures by a wheel manufacturing means, and delivers the name-provided aluminum wheel manufactured, to the customer by a transport means or by such a method that the customer directly comes to receive the name-provided aluminum wheel manufactured (step S305). (Or, it is also possible to directly deliver the name-provided aluminum wheel manufactured, from the wheel maker.)

Therefore, according to this embodiment, the wheel supplier becomes a main constituent. And, it is possible to provide a personal or original design wheel as a trading configuration of a completed wheel, from the wheel supplier to the customer, similarly to the above-mentioned first and second embodiments. The personal or original design wheel incorporates a partially special specification such a name, design or the like requested by the customer in a wheel basic specification, and emphasizes a personal taste, and is different from the others, and has highly original design relative to an object of the customer such as an individual or the like.

(Forth Embodiment)

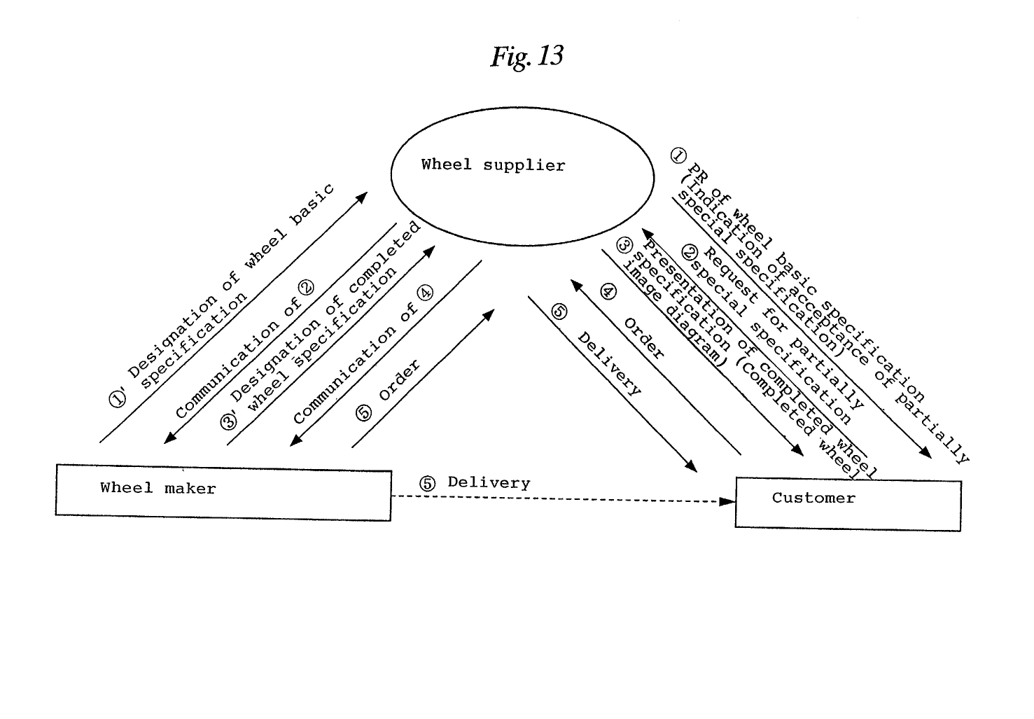

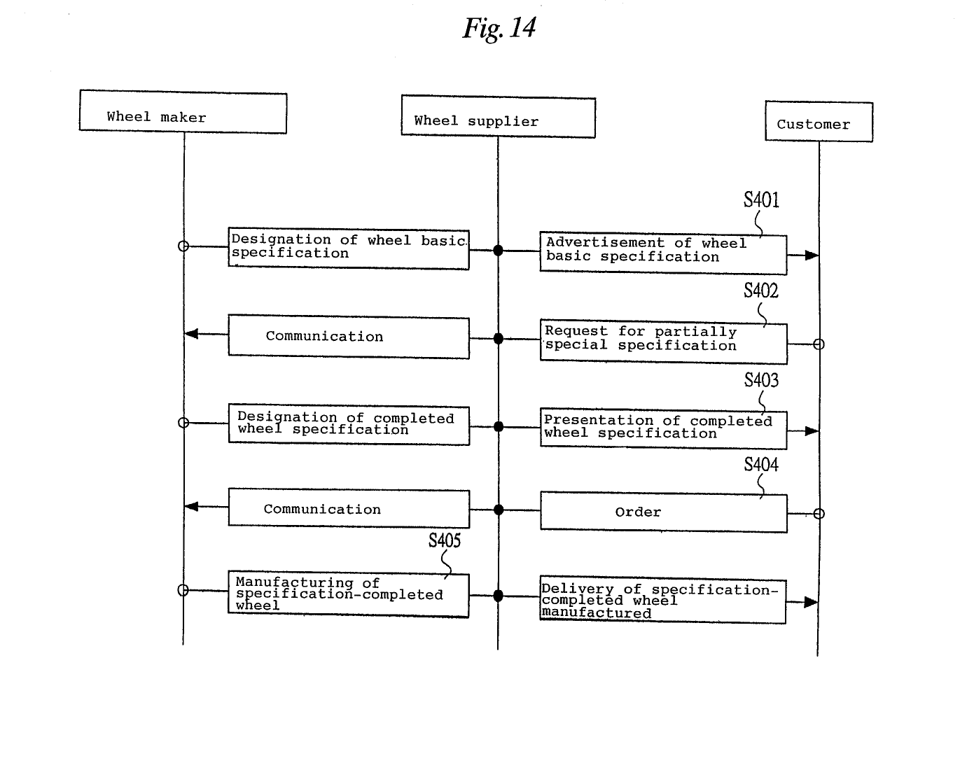

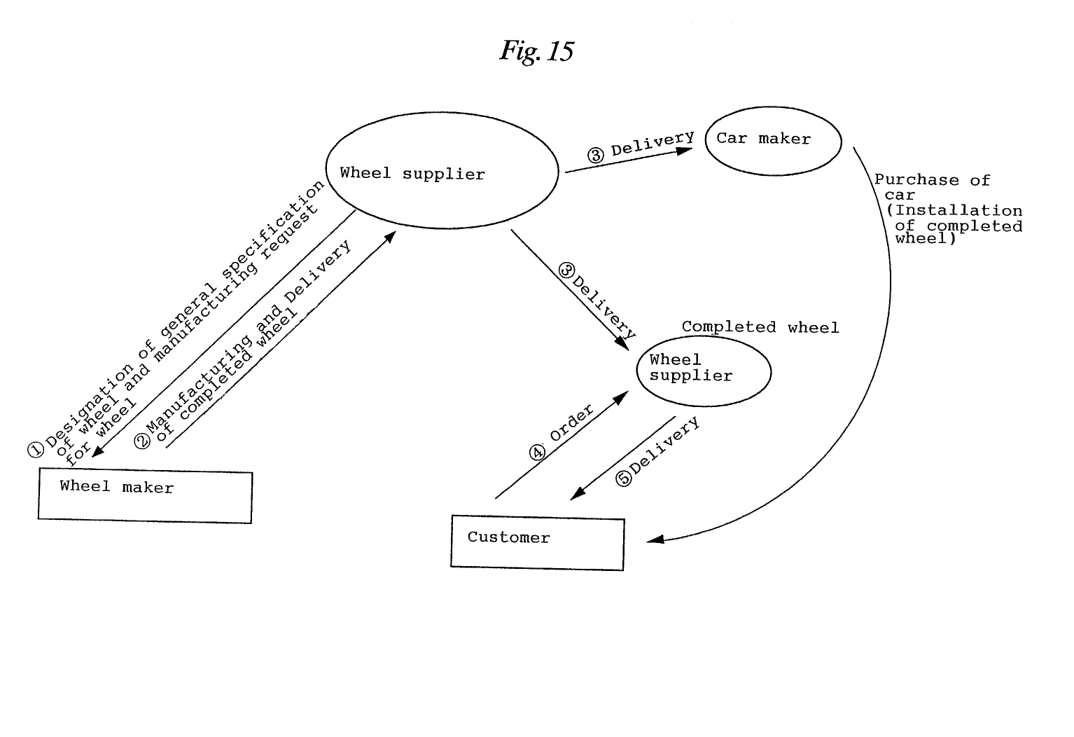

FIG. 13 is a conceptual illustration showing a vehicle wheel trading method of a forth embodiment of the present invention. FIG. 14 is a flowchart showing a vehicle wheel trading method by a system for executing the vehicle wheel trading method of this embodiment.

The vehicle wheel trading method of this embodiment is different from the vehicle wheel trading methods of the above-mentioned embodiments 1 to 3 in that a wheel-basic-specification-designating company is a wheel maker, the wheel maker becomes a main constituent, the wheel supplier receives designation of a wheel basic specification from the wheel maker, and vehicle wheels are traded between the wheel supplier and a customer. That is, in the case of this embodiment, as shown by an example in FIG. 13, every transaction is performed via a wheel supplier, the wheel supplier receives designation of a wheel basic specification from a wheel maker and advertises the wheel basic specification to a customer (\mathring{1}, \mathring{1}′), receives a request for a partially special specification from the customer and then communicates the partially special specification to the wheel maker (\mathring{2}), receives designation of a completed wheel specification incorporating the partially special specification in the wheel basic specification from the wheel maker and then presents the completed wheel specification to the customer (\mathring{3}, \mathring{3}′), obtains an order from the customer (\mathring{4}), and thereafter delivers a specification-completed wheel to the customer (or the wheel maker directly delivers the wheel to the customer) (\mathring{5}). Symbols \mathring{1} to \mathring{5} in FIG. 13 correspond to described hereinafter steps S401 to S405 in FIG. 14, respectively.

A system for executing the vehicle wheel trading method of this embodiment according to the concept in FIG. 13 is similar to the case of, for example, the above-mentioned third embodiment (FIG. 11). In the system, vehicle wheels are traded between a wheel maker and a customer through a wheel supplier by using a communication network. The system is constituted by connecting terminal device 1 of the wheel maker, the terminal device 2 of the customer, and the terminal device 6 of the wheel supplier to the communication network 3.

Accordingly, as shown by an example in FIG. 14, the vehicle wheel trading method of this embodiment makes it possible that a wheel supplier receives designation of a wheel basic specification from a wheel maker and advertises the wheel basic specification to a customer (step S401), receives a request for a partially special specification from the customer and communicates the request for the partially special specification to the wheel maker (step S402), receives designation of a completed wheel specification of an aluminum wheel from the wheel maker and then presents the completed wheel specification to the customer (step S403), obtains an order from the customer and then communicates the order to the wheel maker (step S404), and receives a name-provided aluminum wheel which the wheel maker manufactures by using a wheel manufacturing means, and then delivers the name-provided aluminum wheel manufactured, to the customer by a transport means or such a method that the customer directly comes to receive the name-provided aluminum wheel manufactured (step S405) (or it is also possible for the wheel maker to directly deliver the wheel to the customer).

Therefore, according to this embodiment, the customer corresponds to the wheel supplier. However, the wheel maker becomes a main constituent. And, it is possible to provide a personal or original design wheel as a trading configuration of a completed wheel from the wheel supplier to the customer, similarly to the above-mentioned first, second and third embodiments. The personal or original design wheel incorporates a partially special specification, such as a name, design or the like requested by the customer in a wheel basic specification, and emphasizes a personal taste, and is different from the others, and has highly original design relative to an object of the customer such as an individual or the like.

The present invention is not restricted to the above-mentioned embodiments. It is needless to say that various modifications are made without departing from the gist of the present invention. That is, any completed wheel trading art may be used as long as a wheel basic specification is communicated to a customer and a partially special specification of the customer is incorporated in the wheel basic specification. For example, for the above embodiments, a case is described in which the whole transaction is performed on a communication network such as Internet or PC-VAN serving as transmission means. However, it is also allowed to perform some of transactions through Internet and remaining transactions through other means. For example, it is possible to open the presentation of a wheel basic specification to the public through Internet, and perform a communication of a partially special specification as digital-camera-taken image file from a customer on the browser of Internet or e-mail, or by facsimile, mailing or the like, and perform ordering and payment by Internet, e-mail, facsimile, mail, or the like.

As described above, according to a vehicle wheel trading method of the present invention, the following advantages can be obtained.

(1) A customer can not purchase a wheel having design other than design specified by a wheel supplier or a car maker in the case of a conventional trading configuration, but can order a personal vehicle wheel having highly original design, which includes an aluminum wheel or the like being an important security part and a mass-production product and is unique in the world and can be purchased at comparatively low cost, without anxiety.

(2) Because individual needs are fed back to a wheel maker or wheel supplier, a customer can obtain a personal vehicle wheel being unique in the world and simultaneously the wheel maker or the like can early grasp various trends which each customer needs.

(3) When a function (3D) for confirming a name or a piece of design being input by a customer on Internet is developed in future, a wheel having a piece of design unique to an individual is ordered after the customer has a confirmation. Therefore, it is possible to realize a vehicle-wheel-trading configuration in which vehicle-wheel-manufacturing and -trading sides have low risk and respective sides have advantage.

(4) Because a name-provided wheel has a burglarproof effect, the customer can obtain the wheel by which a sense of solidarity is increased if a name or mark in a club, team or the like is unified.

What is claimed is:

1. A vehicle wheel trading method comprising:
a step of communicating a wheel basic specification of a wheel-basic-specification-designating company to a customer;
a step of communicating a request for a partially special specification of the customer as corresponding to the wheel basic specification, to a wheel maker;
a step of manufacturing a specification-completed wheel incorporating the partially special specification in the wheel basic specification by a manufacturing means which the wheel maker uses; and
a step of delivering the specification-completed wheel manufactured by the wheel maker to the customer.

2. A vehicle wheel trading method comprising:
a step of communicating a wheel basic specification of a wheel-basic-specification-designating company to a customer by a transmission means;
a step of communicating a request for a partially special specification of the customer as corresponding to the wheel basic specification, to wheel maker by a transmission means;
a step of manufacturing a specification-completed wheel incorporating the partially special specification in the wheel basic specification by a manufacturing means which the wheel maker uses; and
a step of delivering the specification-completed wheel manufactured by the wheel maker to the customer.

3. A vehicle wheel trading method comprising:
a step of communicating a wheel basic specification of a wheel maker to a customer by a transmission means;
a step of communicating a request for a partially special specification of the customer as corresponding to the wheel basic specification, to the wheel maker by transmission means;
a step of manufacturing a specification-completed wheel incorporating the partially special specification in the wheel basic specification by a manufacturing means which the wheel maker uses; and
a step of delivering the specification-completed wheel manufactured by the wheel maker to the customer wherein a wheel-basic-specification-designating company is the wheel maker.

4. A vehicle wheel trading method comprising:
a step of communicating a wheel basic specification of a wheel maker to a customer via a wheel broker by a transmission means;
a step of communicating a request for a partially special specification of the customer as corresponding to the wheel basic specification, to the wheel maker by a transmission means via the wheel broker by a transmission means;
a step of manufacturing a specification-completed wheel incorporating the partially special specification in the wheel basic specification by a manufacturing means which the wheel maker uses; and
a step of delivering the specification-completed wheel manufactured by the wheel maker to the customer wherein a wheel-basic-specification-designating company is the wheel maker.

5. A vehicle wheel trading method comprising:
a step of communicating a wheel basic specification of a wheel supplier to a wheel maker by a transmission means;
a step of communicating the wheel basic specification from the wheel supplier to the wheel maker by a transmission means;
a step of communicating a request for a partially special specification of the customer as corresponding to the wheel basic specification, to the wheel supplier by a transmission means;
a step of communicating a request for the partially special specification from the wheel supplier to the wheel maker by a transmission means;
a step of manufacturing a specification-completed wheel incorporating the partially special specification in the wheel basic specification by a manufacturing means which the wheel maker uses; and
a step of delivering the specification-completed wheel manufactured by the wheel maker to the customer wherein a wheel-basic-specification-designating company is the wheel supplier.

6. A vehicle wheel trading method comprising:
a step of communicating a wheel basic specification of a wheel maker to a customer via a wheel supplier by a transmission means;
a step of communicating a request for a partially special specification of the customer as corresponding to the wheel basic specification, to the wheel maker via the wheel supplier by a transmission means;
a step of manufacturing a specification-completed wheel incorporating the partially special specification in the wheel basic specification by a manufacturing means which the wheel maker uses; and
a step of delivering the specification-completed wheel manufactured by the wheel maker to the customer wherein a wheel-basic-specification-designating company is the wheel maker.

7. A vehicle wheel trading method according to claim 1, wherein
the partially special specification is a specification provided with at least one of name, character, mark, family crest, picture, partially individual coating, sensor, and LED.

8. The vehicle wheel trading method according to claim 1, wherein
the transmission means includes a communication network, and
respective transactions between the wheel maker and the customer, between the wheel maker, the wheel broker, and the customer, and between the wheel maker, the wheel supplier, and the customer through the communication network are performed by using terminal devices of the wheel maker, the customer, the wheel broker, and the wheel supplier.

9. The vehicle wheel trading method according to claim 1, wherein
the vehicle wheel includes a wheel made of a light alloy for an automobile and the partially special specification includes a name.

10. The vehicle wheel trading method according to claim 4, wherein
the transmission means includes a communication network, and
respective transactions between the wheel maker and the customer, between the wheel maker, the wheel broker, and the customer, and between the wheel maker, the wheel supplier, and the customer through the communication network are performed by using terminal devices of the wheel maker, the customer, the wheel broker, and the wheel supplier.

11. The vehicle wheel trading method according to claim 5, wherein
the transmission means includes a communication network, and
respective transactions between the wheel maker and the customer, between the wheel maker, the wheel broker, and the customer, and between the wheel maker, the wheel supplier, and the customer through the communication network are performed by using terminal devices of the wheel maker, the customer, the wheel broker, and the wheel supplier.

12. The vehicle wheel trading method according to claim 6, wherein
the transmission means includes a communication network, and
respective transactions between the wheel maker and the customer, between the wheel maker, the wheel broker, and the customer, and between the wheel maker, the wheel supplier, and the customer through the communication network are performed by using terminal devices of the wheel maker, the customer, the wheel broker, and the wheel supplier.
